(19) United States
(12) Patent Application Publication
(10) Pub. No.: US 2004/0205544 A1
(43) Pub. Date: Oct. 14, 2004

(54) Inline error highlighting

(75) Inventors: Radhika Aggarwal, Raleigh, NC (US); William H. Krebs JR., Cary, NC (US); Elizabeth A. Schreiber, Apex, NC (US); David B. Styles, Cary, NC (US)

Correspondence Address: IBM Corporation T81/062, PO Box 12195, Research Triangle Park, NC, 27709, US

(73) Assignee: International Business Machines Corporation, Armonk, NY

(21) Appl. No.: 10/041,141

(22) Filed: Jan. 3, 2002

(51) Int. Cl. G06F 17/24

(52) U.S. Cl. 715/512; 715/530

(57) ABSTRACT

An inline error notification method. An error notification method can include detecting in a form-based submit, at least one validation error based upon a value provided through an input-element in a markup specified form. Upon detecting a validation error, a row can be inserted in the markup specified form in a position which is proximate to the input-element. In particular, the row can be assigned a background color which differs from other colors which are visible in proximity to the inserted row. Error text can be selected which corresponds to the validation error. Subsequently, the selected error text can be inserted in the row. An anchor tag can be further inserted in the markup specified form in a position which is proximate to the input-element. Finally, the markup specified form can be served in a response to the form-based submit, the response referencing the anchor tag.

### BACKGROUND OF THE INVENTION

1. Technical Field

The present invention relates to rendering user interface elements in a content browser and more particularly to performing inline error notification in a content browser.

2. Description of the Related Art

Prior to the popularization of the Internet and the subsequent deployment of the World Wide Web, software publishers typically distributed computer applications via storage media such as a computer diskette or compact disc. Initially, such computer applications included underlying program logic, data storage and, optionally, a user interface. Over time, as the processing capabilities of underlying computing devices evolved, increasingly more complex user interfaces were developed for use with corresponding computer applications. In particular, the advent of the graphical user interface (GUI) resulted in an expectation among end users that a computer application include an intuitive and aesthetically pleasing graphical interface through which end users could effectively interact with the computer application.

Recently, given the popularization of the Internet and the World Wide Web, it is no longer reasonable to presume that computer applications are distributed exclusively via disk medium. Rather, in many cases, conventional computer programs are distributed electronically via the Internet. More importantly, however, in many cases computer applications are no longer distributed as stand-alone executable programs. Rather, many computer applications are distributed as Web applications which can include a collection of hypermedia documents such as Web pages which can be viewed in hypermedia content browsers such as Web browsers.

In the case of a Web application, users interact with the underlying program logic not through a traditional GUI, but through a GUI provided by widgets embedded in a hypermedia document displayed in a hypermedia content browser. Unfortunately, Web-based GUIs do not enjoy the same flexibility of the conventional GUI. Specifically, GUI widgets which can be dynamically modified during run-time are not also included as part of a Web-enabled GUI. In fact, fundamental limitations of modern markup languages prohibit software developers from accessing “basic” GUI components such as inline error notifications.

Inline error notifications are graphical mechanisms which alert an end-user to an error condition. In conventional software applications, form-based user-interactions often make extensive use of inline error notifications, particularly in the case of validating user-provided form-based input. For instance, a typical inline error notification can include notifying an end-user when a provided value falls outside of the range of permissible values as would be the case where a user specifies the number 32 in reference to a day in a particular month, or the letter “A” in reference to one's age.

Though it is important to be able to emulate inline error notifications in Web applications, such emulation is not easily undertaken. Specifically, in a conventional application, inline error notifications can be provided through simple message boxes, or more complex pop-up dialog boxes. Alternatively, the GUI itself can repaint itself to include the notification in close proximity to the erroneous entry. In a Web application, however, message boxes and dialog boxes are not GUI elements which can be provided without the use of embedded scripting and program logic requiring advanced processing in the content browser.

For instance, it is known to emulate inline error notifications using JavaScript and Dynamic HTML. Still, some conventional Web browsers cannot process JavaScript or Dynamic HTML and are configured only to process basic versions of HTML, such as HTML 3.2. Moreover, the activation of inline error highlighting facilitated through JavaScript and Dynamic HTML often require extensive communications between the content browser and content server. Extensive communications between the content server and content browser, however, can detract from the performance of the Web application.

### SUMMARY OF THE INVENTION

The present invention is an inline error notification method for use in content browsers which overcomes the deficiencies of the prior art. Advantageously, unlike prior art inline error notification methods, in the present invention, inline error notification can be emulated without expending processing resources which otherwise would be expended when using JavaScript, DHTML or such other client side processing technologies. Rather, in the present invention inline error notification can be emulated using markup which can be rendered even in skeletal content browsers capable only of processing HTML 3.2.

In one aspect of the present invention, an error notification method can include detecting in a form-based submit, at least one validation error based upon a value provided through an input-element in a markup specified form. Upon detecting a validation error, a row can be inserted in the markup specified form in a position which is proximate to the input-element. In particular, the row can be assigned a background color which differs from other colors which are visible in proximity to the inserted row. Error text can be selected which corresponds to the validation error. Subsequently, the selected error text can be inserted in the row.

Notably, an anchor tag can be further inserted in the markup specified form in a position which is proximate to the input-element. Also, where it can be determined that the markup specified form contains multiple views in which one of the views contains the input-element; the one view containing the input-element can be set to a visible status. In any case, the markup specified form can be served in a response to the form-based submit, the response referencing the anchor tag.

The inline error notification method further can include inserting an error image adjacent to the input-element. Also, the step of inserting a row in the markup specified form in a position which is proximate to the input-element can include inserting a row in the markup specified form in a position which is proximate to but below the input-element. Finally, the step of inserting an anchor tag in the markup specified form can include further inserting an anchor tag in the markup specified form in a position which is proximate to but before the input-element.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic illustration of a system which has been configured to render inline error notification in a content browser in accordance with the inventive arrangements;

FIGS. 2A and 2B, taken together, are a pictorial illustration of an exemplary form-based transaction utilizing the inline error notification system of the present invention; and,

FIG. 3 is a flow chart illustrating an inline error notification method for use in teh system of FIG. 1.

### DETAILED DESCRIPTION OF THE PREFERRED EMBODIMENTS

The present invention is an inline error notification system and method for use in content browsers which overcomes the deficiencies of the prior art. Specifically, when a validation error has been detected among submitted values provided by an end-user in a form, the form can be modified with an inline error notification markup. In the present invention, the inline error notification can include highlighted error text and can be provided in a position in the form which is proximate to the input-element in the form in which the validation error has occurred. Additionally, using conventional anchor tags, the subsequent display of the modified form can be configured to scroll to a level proximate to the input-element.

In this way, not only will the error notification appear distinctive to an end-user, but the error notification will be apparent to the end-user even where the error has occurred in a position in the form well below the displayable area of the content browser. Finally, it will be apparent to one skilled in the art that the inline error notification described herein can be implemented without requiring the use of scripting languages. Rather, the forms generated by the inline error notification system of the present invention can be implemented using only those facilities provided by conventional markup languages such as HTML 3.2.

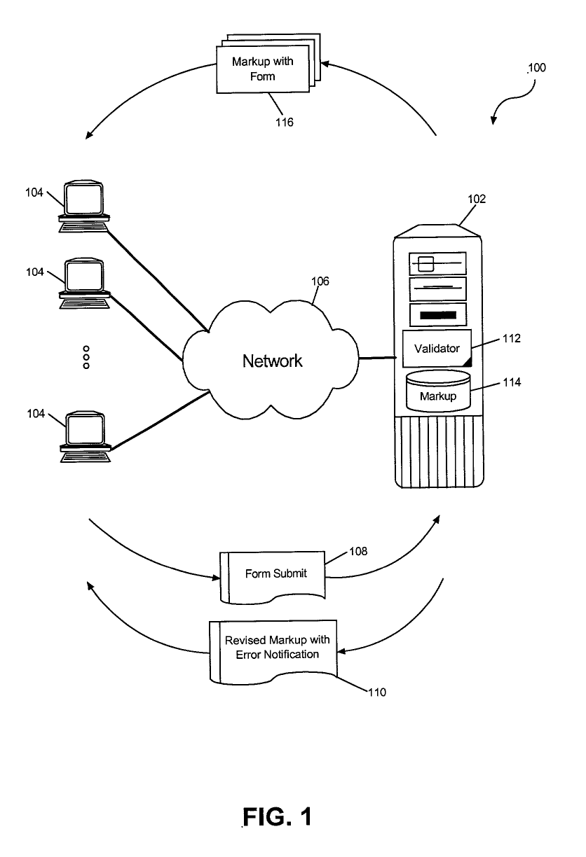

FIG. 1 is a schematic illustration of an inline error notification system 100 which has been configured to render an inline error notification in a content browser in accordance with the inventive arrangements. As shown in FIG. 1, the system 100 can include one or more end-users 104 accessing a content server 102 through a computer communications network 106. In particular, the content server 102 can access markup 114 which specifies network distributable content interpretable and displayable in a content browser. Notably, though FIG. 1 depicts the markup 114 as being included within the content server 102, the invention is not so limited to the location of the markup 114.

In response to receiving suitably formatted requests forwarded by the end-users 104, the content server 102 can retrieve selected portions of the markup 1 14, the selected portions forming “pages”, sometimes referred to as Web pages. Still, the invention is not limited merely to HTML formatted Web pages and can be included in other types of network distributable content which can be specified by other types of markup languages such as XML, WML, etc. Once the content server 102 has retrieved suitable pages in response to a corresponding request, the content server 102 can “serve” the retrieved pages to the requesting end-users 104.

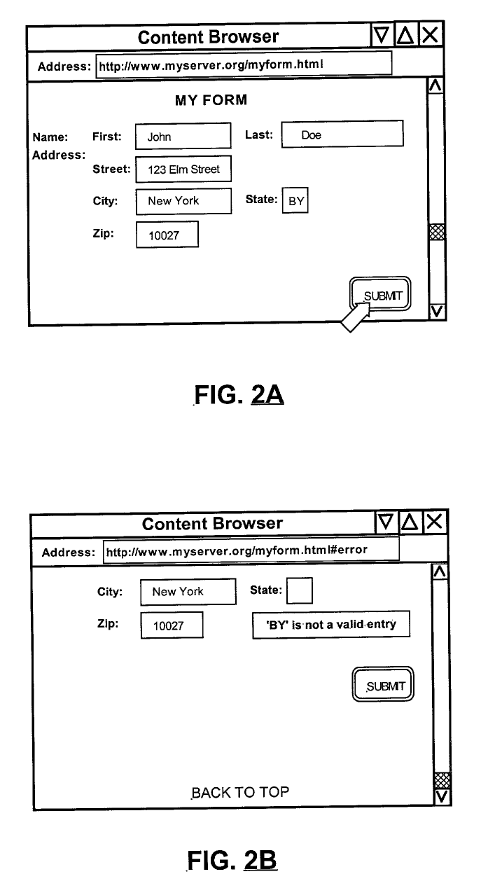

Importantly, in the present invention, the selected portions of the markup 114 can specify a form. FIG. 2A is a pictorial illustration of an exemplary form for use in the present invention. Forms are well-known user interface tools which can include one or more input elements. As shown in the exemplary form of FIG. 2A, similar to a conventional, paper form, an electronic form which has been specified in markup can prompt an end-user to provide information and can permit an end-user to enter the prompted information in specified input fields. Once an end-user has completed an electronic form, the end-user can “submit” the form by selecting a form-based submit element, as will be recognized by one skilled in the art. HTML 3.2 is a markup language which provides markup tags useful for defining forms and their respective input elements.

Returning now to FIG. 1, as the selected portion of the markup 114 can specify a form, the form 116 can be forwarded to requesting end-users 104 in which the form 116 can be rendered by a content browser, such as a browser configured to process HTML 3.2. Once the content browser has rendered the form, the end-users 104 can interact with the form, particularly providing requested data in the various input elements of the form 116. Once the end-users 104 have completed the form 116, the end-users 116 can submit the completed form in the form of a form submit 108.

Upon receipt of the form submit 108, the content server 102 can parse the completed form and can validate the data provided by the end-user. In particular, a validation process 112 can be accessed by the content server 102 which can ensure that each data value provided by the end-user in an input element in the form falls within a permissible range of values for the associated input element. If during the validation process 112, one or more values are determined to fall outside the range of permissible values, an inline error notification can be generated and provided to the end-user 104 in an effort to prompt the end-user 104 to provide valid data.

For example, FIG. 2B illustrates an exemplary form containing an inline error notification in accordance with the inventive arrangements. As shown in FIG. 2B, an inline error notification can be provided in response to an end-user having provided the abbreviation “BY” where an abbreviation for one of the fifty states of the United States had been expected. As “BY” falls outside of the permissible range of the fifty states, an inline error notification has been positioned in a row below the “State” input element. Additionally, in order to draw attention to the error notification, the background of the inline error notification has been altered to differ from the background of the “State” input element and its surroundings. Finally, as will be apparent to one skilled in the art, the content browser display has scrolled to the portion of the form containing the “State” object so that the inline error notification is visible to the end-user.

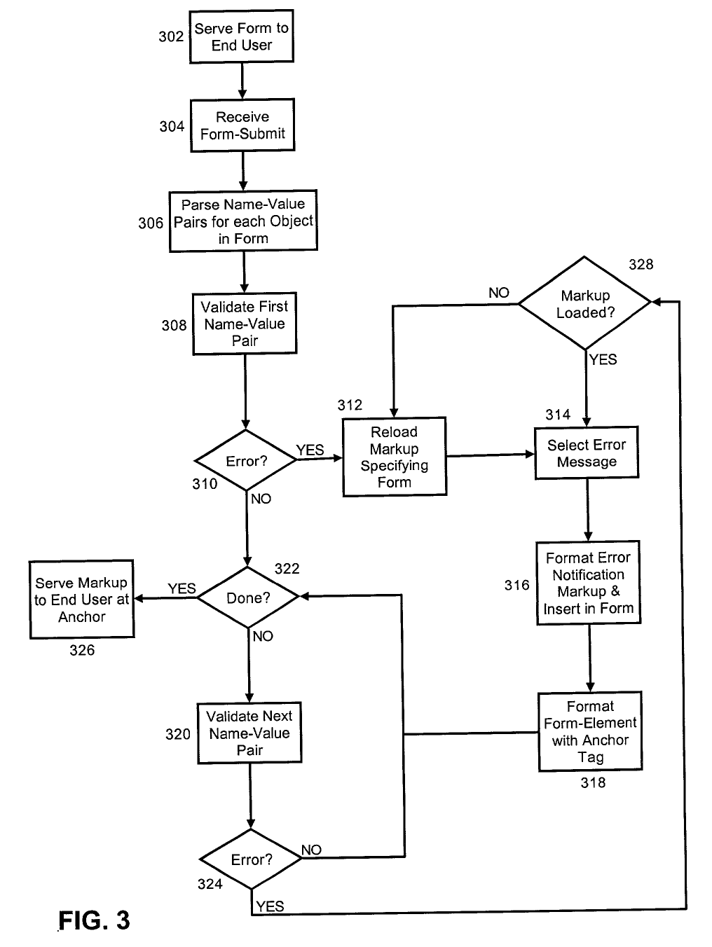

FIG. 3 is a flow chart illustrating an inline error notification method for use in the system of FIG. 1. Beginning in step 302, markup specifying a form and its constituent input elements can be served to an end-user in a manner in which it can be rendered in a compatible content browser. For example, a form can be specified using suitable markup tags according to the HTML 3.2 specification, though the invention is not limited in regard to the particular markup language used to specify the form. The form can be served using a conventional Web server and can be rendered in a conventional Web browser configured to render HTML 3.2. Once rendered, the end-user can interact with the form, providing values where prompted therein.

When the end-user has completed the form, the end-user can submit the form, typically by selecting a form-submit input element such as a submit button. Upon selecting the form-submit input element, a string can be generated which contains the names of each of the input elements in the form in addition to their respective values. In step 304, the string can be received in the content server and in block 306 the string can be parsed. In particular, in block 306, each name-value pair provided in the string can be extracted therefrom using name-value parsing techniques well-known in the art.

In blocks 308 and 310, the first name-value pair can be validated to ensure its conformance with an acceptable set or range of values for a corresponding input element. For instance, where the input element has requested an integer, a decimal value can be identified as an error. Likewise, where an input element has prompted an end-user for an age, an alphabetic character such as the letter “C” can be flagged as an error. In any case, the invention is not so limited by the type of validation performed for each name-value pair. Rather, any type of validation rule can be applied to the values provided by the end-user in the form, and the invention can provide an inline error notification responsive to detecting an error, regardless of the validation rule giving rise to the error.

If in block 310, the first name-value pair passes validation, in block 322 it can be determined whether any name-value pairs remain to be validated. If so, in block 320 the next name-value pair in the string can be validated and, again, in block 324, it can be determined whether the value fails to validate. If not, the process of blocks 320 through 324 can repeat until no name-value pairs remain. Otherwise, if a validation error is detected, either in block 310 or in block 324, an inline error notification process can commence in accordance with the inventive arrangements.

In particular, returning to block 310, if a validation error is detected for a value in the first name-value pair in the string, the markup specifying the form can be loaded in block 312. Subsequently, in block 314, a suitable textual error message can be selected based upon the type of validation error which has occurred. For instance, the validation error can produce a code which can act as an index into a table of textual error messages. In any event, in block 316, markup specifying a row can be inserted into the markup specifying the form. The markup specifying the row can further specify the placement of the row at a position which is proximate to the input-element which gave rise to the validation error. In a preferred aspect of the invention, the row can be positioned below the input-element.

Also in block 316, the textual error message selected in block 314 can be inserted into the row. Importantly, to visually distinguish the inline error notification from the rest of the form, the background of the row can assume a color which differs from the colors of the input element and its surroundings. By differing, it is meant that the row is “highlighted” in a manner similar to conventional highlighting. Optionally, an image denoting an error can be inserted adjacent to the input-element. Finally, to ensure the visibility of the error notification, in step 318 an anchor tag can be applied proximately to the input-element. In consequence, when the page containing the form is reloaded, the anchor can be specified in the URL causing the page to scroll to a position which is proximate to the input-element. Notably, where the page contains hidden elements not accessible by scrolling, for example an advanced GUI notebook containing frames accessible through tabs, or a wizard containing a series of sequentially positioned frames, instead of only using an anchor, in addition the desired view can be set to “visible” using techniques which are well-known in the art.

Importantly, if the first validation error is detected not in association with the first name-value pair, but with a subsequent name-value pair, in block 328 first it can be determined whether the markup specifying the form has been previously loaded into memory in which the markup can be modified. If not, in block 312, the markup can be loaded, otherwise, the process can be performed in the same manner as described above beginning in block 314 and continuing through block 318. In any case, once the inline error notification has been inserted into the markup specifying the form, the process can return to block 322 in which it can be determined whether additional name-value pairs remain to be processed. If no name-value pairs remain to be validated, in block 326 the modified markup specifying the inline error notification can be served to the end user using a URL which directs the content browser of the user to scroll to an anchor positioned specified therein.

The present invention can be realized in hardware, software, or a combination of hardware and software. A method and apparatus for emulating an inline error notification according to the present invention can be realized in a centralized fashion in one computer system, or in a distributed fashion where different elements are spread across several interconnected computer systems. Any kind of computer system, or other apparatus adapted for carrying out the methods described herein, is suited.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. An inline error notification method comprising:
detecting in a form-based submit, at least one validation error based upon a value provided through an input-element in a markup specified form;
inserting a row in said markup specified form in a position which is proximate to said input-element, said row having a background color which differs from other colors which are visible in proximity to said inserted row;
selecting error text corresponding to said validation error and inserting said selected error text in said row;
further inserting an anchor tag in said markup specified form in a position which is proximate to said input-element; and,
serving said markup specified form in a response to said form-based submit, said response referencing said anchor tag.

2. The inline error notification method of claim 1, further comprising the step of:
inserting an error image adjacent to said input-element.

3. The inline error notification method of claim 1, further comprising the steps of:
determining whether said markup specified form contained multiple views, one of said multiple views containing said input-element; and,
if it is determined that said markup specified form contains multiple views, identifying said one of said multiple views and setting said identified one of said multiple views to a visible status.

4. The inline error notification method of claim 1, wherein said step of inserting a row in said markup specified form in a position which is proximate to said input-element comprises the step of:
inserting a row in said markup specified form in a position which is proximate to but below said input-element, said row having a background color which differs from other colors which are visible in proximity to said inserted row.

5. The inline error notification method of claim 4, wherein said step of further inserting an anchor tag in said markup specified form in a position which is proximate to said input-element comprises the step of:
further inserting an anchor tag in said markup specified form in a position which is proximate to but before said input-element.

6. A machine readable storage having stored thereon a computer program for performing inline error notification, said computer program comprising a routing set of instructions for causing the machine to perform the steps of:
detecting in a form-based submit, at least one validation error based upon a value provided through an input-element in a markup specified form;
inserting a row in said markup specified form in a position which is proximate to said input-element, said row having a background color which differs from other colors which are visible in proximity to said inserted row;
selecting error text corresponding to said validation error and inserting said selected error text in said row;
further inserting an anchor tag in said markup specified form in a position which is proximate to said input-element; and,
serving said markup specified form in a response to said form-based submit, said response referencing said anchor tag.

7. The machine readable storage of claim 6, further comprising the step of:
inserting an error image adjacent to said input-element.

8. The machine readable storage of claim 6, further comprising the steps of:
determining whether said markup specified form contained multiple views, one of said multiple views containing said input-element; and,
if it is determined that said markup specified form contains multiple views, identifying said one of said multiple views and setting said identified one of said multiple views to a visible status.

9. The machine readable storage of claim 6, wherein said step of inserting a row in said markup specified form in a position which is proximate to said input-element comprises the step of:
inserting a row in said markup specified form in a position which is proximate to but below said input-element, said row having a background color which differs from other colors which are visible in proximity to said inserted row.

10. The machine readable storage of claim 9, wherein said step of further inserting an anchor tag in said markup specified form in a position which is proximate to said input-element comprises the step of:
further inserting an anchor tag in said markup specified form in a position which is proximate to but before said input-element.
